(19) United States
(12) Patent Application Publication
(10) Pub. No.: US 2008/0276799 A1
(43) Pub. Date: Nov. 13, 2008

(54) ALUMINUM PISTON WITH AN INCORPORATED SEAL

(75) Inventors: Tomoaki NISHIMURA, Fukushima (JP); Toshiki WATANABE, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/115,747

(22) Filed: May 6, 2008

(30) Foreign Application Priority Data
May 10, 2007 (JP) 2007-125183

(51) Int. Cl. F16J 1/00

(52) U.S. Cl. 92/168

(57) ABSTRACT

In order to reduce product weight, enhance design freedom, reduce production cost and improve productivity, an aluminum piston with an incorporated seal is provided, the piston comprising an aluminum die-cast piston main body (101) arranged to be axially movable in a clutch cylinder (1), a film (102) which is made of a rubber-like elastic material and covers a region from a pressure-receiving end surface (101e) of the piston main body (101) to surfaces (101f, 101g) facing toward the opposite side to said pressure-receiving end surface (101e) through inner and outer peripheral surfaces thereof, and seal lips (103, 104) formed on the film (102) at inner and outer peripheral portions of the piston main body (101) so as to be slidably in close contact with the clutch cylinder (1).

### BACKGROUND OF THE INVENTION

1. Field of the Invention

The present invention relates to an aluminum piston used for a hydraulically actuated clutch of an automatic transmission of a car, in which a seal is formed integrally with the aluminum piston.

2. Description of the Conventional Art

The hydraulically actuated clutch used in an automatic transmission of a car is configured so that a clutch piston moving axially in a clutch cylinder by hydraulic pressure makes drive plates at the side of a drive shaft and driven plates at the side of a driven shaft in a multi-plate clutch to contact by pressure to each other. A piston manufactured by aluminum die casting (hereinafter referred to as “aluminum piston”) is often used as the above-mentioned clutch piston.

FIG. 2 is a half sectional view taken on a plane passing an axis O of the drive shaft, showing a general configuration of the hydraulically actuated clutch using a conventional aluminum piston. In FIG. 2, a reference numeral 1 indicates an annular clutch cylinder rotating with the drive shaft (not shown), a reference numeral 2 indicates an aluminum piston disposed to be axially movable in the clutch cylinder 1, and a reference numeral 3 indicates a disc-shaped spring holder disposed axially opposing to the aluminum piston 2 and fixed to the inner peripheral tubular portion 1b of the clutch cylinder 1 through a snap ring 31. A reference numeral 4 indicates a multi-plate clutch comprising a plurality of drive plates 41 and a plurality of driven plates 42 disposed alternately in the axial direction of clutch cylinder 1, in which the drive plates 41 are engaged circumferentially to the clutch cylinder 1 to be axially movable, and the driven plates 42 are engaged circumferentially to a clutch hub 43 provided at the side of a driven shaft (not shown) to be axially movable. An outer peripheral hem portion 2a of the aluminum piston 2 is disposed axially opposing to the drive plate 41 of the multi-plate clutch 4, and a plurality of return springs 5 are arranged circumferentially around the axis O at specified intervals between the aluminum piston 2 and the spring holder 3 under a properly compressed state.

There are formed contiguous grooves on the inner and outer peripheral surfaces of the aluminum piston 2 so as to extend circumferentially around the axis O, and seal rings 21, 22 (for example, O-rings) made of a rubber-like elastic material fitted to the grooves are disposed slidably in close contact with the inner peripheral tubular portion 1b and an outer peripheral tubular portion 1c of the clutch cylinder 1 respectively. Further, an oil passage 11 is provided in the inner peripheral tubular portion 1b of the clutch cylinder 1 for introducing oil pressure of operating oil (ATF) into an oil pressure chamber 6 defined between an end disc portion 1a of the clutch cylinder 1 and the aluminum piston 2.

Namely, the hydraulically operated clutch is configured so that the aluminum piston 2 moves axially in the clutch cylinder 1 in such a direction as to compress the return spring 5 by applying oil pressure to the oil pressure chamber 6 through the oil passage 11, thereby the drive plates 41 of the multi-plate clutch 4 are pressed toward the driven plates 42 to provide the connection state under which power is transmitted from the drive shaft to the driven shaft.

Next, when the oil pressure in the oil pressure chamber 6 is released, the aluminum piston 2 moves axially in the clutch cylinder 1 in such a direction as to decrease the volume of the oil pressure chamber 6 by energized force of the return spring 5, thereby to release the pressure contact between the driving plates 41 and the driven plates 42 in the multi-plate clutch 4 to shut off the power transmission from the drive shaft to the driven shaft. One example of the conventional hydraulically operated clutch using such an aluminum piston as shown in FIG. 2 is disclosed in the Japanese unexamined patent publication No. 9-242784.

While the aluminum piston has an advantage that the piston can be manufactured with reduced weight and with broader design flexibility, however, there is a disadvantage that the number of parts and assembly processes are increased due to the necessity for employing such independent parts as the seal rings 21 and 22 for sealing between the piston 2 and the inner peripheral tubular portion 1b and the outer peripheral tubular portion 1c of the clutch cylinder 1. Further, it is pointed out that the aluminum die-cast product is likely affected by the problem of molding cavities which may be produced in a molding process and make the product defective.

The above-mentioned problem will be described further in detail. The grooves 2b and 2c formed on the aluminum piston 2 to attach the seal rings 21 and 22 are made by machining for tighter contact with the seal rings 21 and 22, however, there is often the case that cavities produced inside the aluminum piston 2 during a molding process appear on the surface by machining of the aluminum piston 2 and thus the aluminum piston 2 becomes defective after the machining. That is to say, since the cavities produced inside the die-cast product are not exposed on the surface thereof until machining, the product which looks non-defective before machining is recognized to be defective due to exposed cavities after machining, resulting in that unnecessary machining cost is incurred. In particular, since the grooves 2b and 2c for attaching the seal rings are regions which are required to be machined, if cavities are produced in such regions, there is fear that gaps are produced on the tight contact surfaces between the grooves and seal rings 21 and 22, affecting the sealability therebetween. The present invention is made in order to solve the aforementioned problem technically.

### SUMMARY OF THE INVENTION

In order to solve the aforementioned problem, the present invention provides an aluminum piston with an incorporated seal, comprising an aluminum die-cast piston main body arranged to be axially movable in a clutch cylinder and seal lips made of a rubber-like elastic material and provided at inner and outer peripheral portions of the piston main body so as to be slidably in close contact with said clutch cylinder, wherein the seal lips are formed on a film which is made of a rubber-like elastic material and covers a region from a pressure-receiving end surface of said piston main body to surfaces facing toward the opposite side to said pressure-receiving end surface through inner and outer peripheral surfaces of the piston main body.

According to the aluminum piston with the incorporated seal of the present invention, the aluminum piston can have reduced weight and broader design flexibility, because the piston main body is manufactured by aluminum die casting, and can be manufactured with decreased number of parts and assembly processes, because the seal lips provided slidably in close contact with the clutch cylinder are formed integrally at the inner and outer peripheral portions of the piston main body. Further, the present invention attains the excellent effect of preventing the operating oil leakage through the cavities which are produced in a forming process by aluminum die-casting of the piston main body, even if they are exposed on the surface where the seal lips are attached by machining or the like, because the cavities are covered with rubber of the seal lips.

Furthermore, since adhesiveness of the rubber-like elastic material to the aluminum die-cast piston main body is generally low, there is fear that the rubber-like elastic material film will peel off from the piston main body in the case that the rubber-like elastic material film with the seal lips is adhered only to the side of the pressure-receiving end surface of the piston main body. However, according to the present invention, the film is adhered to the piston main body so as to cover the region from the pressure-receiving end surface of the piston main body to the surface facing toward the opposite side to said pressure-receiving end surface through the inner and outer peripheral surfaces of the piston main body, thereby to prevent the peeling of the film without fail, and to realize an integrated structure of the piston main body with the seal lips.

### BRIEF EXPLANATION OF DRAWINGS

FIG. 1 is a half sectional view taken on a plane passing an axis O showing a general configuration of a hydraulically actuated clutches using the aluminum piston with an incorporated seal according to the present invention, and

FIG. 2 is a half sectional view taken on a plane passing an axis O, showing a general configuration of a hydraulically actuated clutches using a conventional aluminum piston.

### DETAILED DESCRIPTION OF PREFERRED EMBODIMENT

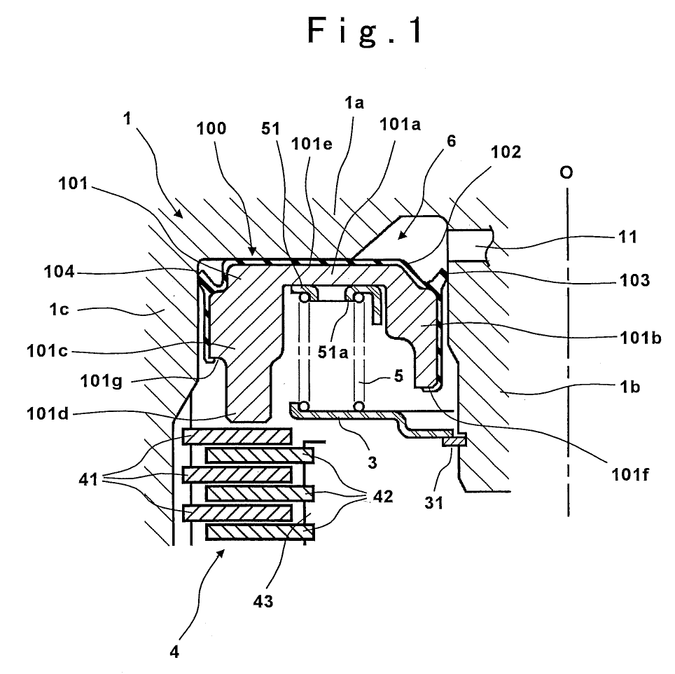

Referring now to FIG. 1, a preferred embodiment of an aluminum piston with an incorporated seal according to the present invention will be described. FIG. 1 is a half sectional view taken on a plane passing an axis O showing a general configuration of a hydraulically actuated clutch using the aluminum piston with an incorporated seal according to the present invention.

In FIG. 1, a reference numeral 1 indicates an annular clutch cylinder rotating with a drive shaft (not shown), a reference numeral 100 indicates an aluminum piston with an incorporated seal (hereinafter referred to as “aluminum piston”) according to the present invention being disposed to be axially movable in the clutch cylinder 1 and defining an oil pressure chamber 6 with an end disc portion 1a of the clutch cylinder 1, and a reference numeral 3 indicates a disc-shaped spring holder disposed axially opposing to the aluminum piston 100 at the opposite side to the oil pressure chamber 6 and fixed to an inner peripheral tubular portion 1b of the clutch cylinder 1 through a snap ring 31, and a reference numeral 4 indicates a multi-plate clutch comprising a plurality of drive plates 41 and a plurality of driven plates 42 disposed alternately in the axial direction of clutch cylinder 1. The drive plates 41 are engaged circumferentially to an outer peripheral tubular portion 1c of the clutch cylinder 1 so as to be axially movable, and the driven plates 42 are engaged circumferentially to a clutch hub 43 provided at the side of a driven shaft (not shown) so as to be axially movable. A reference numeral 5 indicates a plurality of return springs disposed between the aluminum piston 100 and the spring holder 3 under a properly compressed state.

The aluminum piston 100 is of an annular configuration around the axis O and comprises a piston main body 101 disposed to be axially slidable in the clutch cylinder 1, a film 102 made of a rubber-like elastic material and formed so as to cover a region from a pressure-receiving end surface 101e at the oil pressure chamber 6 side thereof to surfaces (an end face 101f and a stepped face 101g) facing toward the opposite side to said pressure receiving end surface 101e through inner and outer peripheral surfaces of the piston main body 101, and seal lips 103, 104 made of a rubber-like elastic material and formed integrally with the film 102.

In particular, the piston main body 101 of the aluminum piston 100 is manufactured by aluminum die casting and comprises a disc portion 101a axially opposing to the end disc portion 1a of the clutch cylinder 1, an inner tubular portion 101b extending from the inner periphery of the disc portion 101a to the opposite side of the oil pressure chamber 6, an outer tubular portion 101c extending from the outer periphery of the disc portion 101a to the opposite side of the oil pressure chamber 6, and a clutch-pressing portion 101d formed on the front end of the outer tubular portion 101c and disposed so as to closely oppose to the drive plate 41 of the multi-plate clutch 4 axially.

The film 102 of the aluminum piston 100 is formed so as to cover a region from the pressure-receiving end surface 101e at the oil pressure chamber 6 side of the disc portion 101a of the piston main body 101 to the end surface 101f of the inner tubular portion 101b facing toward the opposite side to said pressure-receiving end surface 101e through the inner peripheral surface thereof, and also from said pressure-receiving end surface 101e to the stepped surface 101g formed on an outer peripheral surface of the outer tubular portion 101c so as to face toward the opposite side to said pressure-receiving end surface 101e through the outer peripheral surface thereof, and such the film 102 is adhered to the surface of the aluminum piston 100.

The seal lips 103, 104 of the aluminum piston 100 are formed on the film 102 at the inner and outer peripheral portions of the disc portion 101a of the piston main body 101 respectively. The seal lip 103 is at the inner peripheral side provided slidably in close contact with the outer peripheral surface of the inner peripheral tubular portion 1b of the clutch cylinder 1, while the seal lip 104 at the outer peripheral side is provided slidably in close contact with the inner peripheral surface of the outer peripheral tubular portion 1c of the clutch cylinder 1. An oil passage 11 is provided in the inner peripheral tubular portion 1b of the clutch cylinder 1 to introduce oil pressure of operating oil (ATF) into the oil pressure chamber 6.

A return spring 5 is a metallic coil spring, and a plurality of the return springs 5 are disposed circumferentially around the axis O at specified intervals between the disc portion 101a of the piston main body 101 and a spring holder 3 under a properly compressed state. The end at the opposite side to the spring holder 3 of each return spring 5 is held by being fitted to an outer periphery of a guiding projection 51a formed on a metal annular retainer 51, thereby to press the disc portion 101a of the piston main body 101 toward the oil pressure chamber 6 side via the retainer 51.

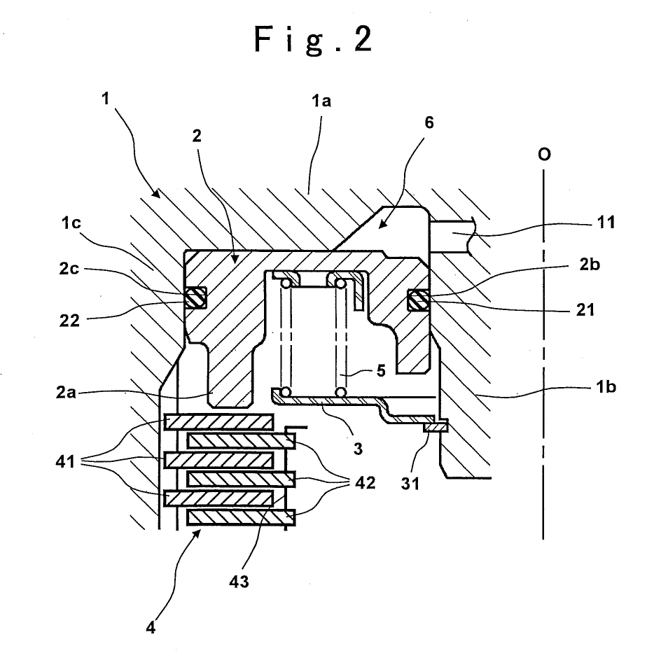

The hydraulically actuated clutch provided with the above-mentioned structure operates in basically the same manner as the conventional one as shown in FIG. 2. Namely, the aluminum piston 100 moves axially in the clutch cylinder 1 by applying operating oil pressure to the pressure chamber 6 through the oil passage 11, or by releasing the oil pressure, thereby to render the multi-plate clutch 4 to perform a connection or disconnection operation.

That is to say, when operation oil is supplied and pressure is given to the oil pressure chamber 6, the aluminum piston 100 moves downward in FIG. 1, while compressing the return spring 5 so that the clutch-pressing portion 101d of the aluminum piston 100 presses the drive plates 41 and driven plates 42 in the multi-plate clutch 4 to frictionally engage them. Consequently, the multi-plate clutch 4 becomes to be in connected state so that driving torque from the drive shaft (not shown) side is transmitted to the driven shaft (not shown) through the clutch cylinder 1, drive plates 41 and driven plates 42 in the multi-plate clutch 4 and clutch hub 43.

On the other hand, in this connected state of the multi-plate clutch 4, when the oil pressure in the oil chamber 6 is released, the aluminum piston 100 moves upward in FIG. 1 by resilience of the compressed return spring 5 so as to decrease the volume of the oil pressure chamber 6. This removes the pressing force applied to the multi-plate clutch 4, thereby the frictional engagement of the drive plates 41 and driven plates 42 in the multi-plate clutch 4 is released so that the transmission of the driving torque from the drive shaft to the driven shaft is shut off.

In the operation, the aluminum piston 100 responds quickly because the piston main body 101 is manufactured by aluminum die casting with reduced weight in comparison with, for example, a piston of thick stainless steel manufactured by pressing, and design flexibility of the piston is broader in comparison with the product manufactured by pressing.

Further, the aluminum piston 100 can be manufactured with decreased number of parts and assembly processes because the seal lips 103 and 104 are formed integrally with the piston main body 101 as means for sealing between the piston body 101 and the inner surface of the clutch cylinder 1. Further, although adhesiveness of the rubber-like elastic material to the aluminum die-cast piston body 101 is generally low, the rubber-like elastic material film 102 on which the seal lips 103 and 104 are integrally formed is adhered to the piston main body 101 so as to cover the region from the pressure-receiving end surface 101e at the oil pressure chamber 6 side of the piston main body 101 to the surfaces (the end face 101f and the stepped face 101g) facing toward the opposite side to the pressure-receiving end surface 101e through the inner and outer peripheral surfaces of the piston main body 101, thereby to prevent the peeling of the film 102 without fail, and to realize an integrated structure of the piston main body 101 with the seal lips 103, 104. Further, even if cavities are produced during the molding process by aluminum die casting, operating oil leakage through the cavities can be prevented. Therefore, defective molding due to cavities is eliminated, and an improved manufacturing yield and reduction in manufacturing cost can be realized.

What is claimed is:

1. An aluminum piston with an incorporated seal comprising:
an aluminum die-cast piston main body arranged to be axially movable in a clutch cylinder; and
seal lips made of a rubber-like elastic material and provided at inner and outer peripheral portions of the piston main body so as to be slidably in close contact with said clutch cylinder,
wherein the seal lips are formed on a film which is made of a rubber-like elastic material and covers a region from a pressure-receiving end surface of said piston main body to surfaces facing toward the opposite side to said pressure-receiving end surface through inner and outer peripheral surfaces of the piston main body.
